(19) United States
(12) Patent Application Publication
(10) Pub. No.: US 2026/0193928 A1
(43) Pub. Date: Jul. 9, 2026

(54) VEHICLE CONTROL DEVICE

(71) Applicant: Toyota Jidosha Kabushiki Kaisha, Toyota-shi (JP)

(72) Inventor: Masayuki YAMAZAKI, Yokohama-shi (JP)

(73) Assignee: Toyota Jidosha Kabushiki Kaisha, Toyota-shi (JP)

(21) Appl. No.: 19/355,288

(22) Filed: Oct. 10, 2025

(30) Foreign Application Priority Data
Jan. 7, 2025 (JP) 2025-002478

(51) Int. Cl. E05F 15/73; G06V 20/58

(52) U.S. Cl. CPC E05F 15/73; G06V 20/58; E05F 2015/767

(57) ABSTRACT

A vehicle control device includes a control unit. The control unit acquires time-series data of an image generated by capturing an image of a landscape outside the vehicle. When a person is detected based on time-series data of an image, the control unit predicts a predicted position of the detected person after a predetermined time. The control unit determines whether or not the detected person intends to get on the vehicle based on a result of determining whether or not a line segment including the detected current position of the person and the detected predicted position of the person is included in the first area and a result of determining whether or not the detected current position of the person is included in the second area. The area of the first area is smaller than the area of the second area.

### CROSS-REFERENCE TO RELATED APPLICATION

This application claims priority to Japanese Patent Application No. 2025-002478 filed on January 7, 2025. The disclosure of the above-identified application, including the specification, drawings, and claims, is incorporated by reference herein in its entirety.

### BACKGROUND

### 1. Technical Field

The present disclosure relates to a vehicle control device.

### 2. Description of Related Art

Japanese Unexamined Patent Application Publication No. 2017-124899 (JP 2017-124899 A) describes an elevator riding detection system that determines that a user intends to ride on an elevator when a state in which the foot position of the user is approaching a door within a preset area is detected and the speed of movement of the user in the direction of the door is equal to or greater than a preset threshold value.

### SUMMARY

The specifications of the vehicle and the elevator are different. It would be useful if it is possible to appropriately determine whether a person intends to ride on the vehicle.

In view of the above, an object of the present disclosure is to appropriately determine whether a person intends to ride on a vehicle.

An aspect of the present disclosure provides a vehicle control device including a control unit that acquires time-series data of an image generated by capturing a scene outside a vehicle. The control unit is configured to

when a person is detected based on the time-series data of the image, predict a predicted position of the detected person after a predetermined time, and

determine whether the detected person intends to ride on the vehicle based on a result of determining whether a line segment including a current position of the detected person and the predicted position of the detected person is included in a first area and a result of determining whether the current position of the detected person is included in a second area.

An area of the first area is smaller than an area of the second area.

According to an embodiment of the present disclosure, it is possible to appropriately determine whether a person intends to ride on a vehicle.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a diagram illustrating a schematic configuration of a vehicle according to an embodiment of the present disclosure;

FIG. 2 is a flowchart showing an exemplary operation of the vehicle control device shown in FIG. 1; and

FIG. 3 is a diagram illustrating an example of an image.

### DETAILED DESCRIPTION OF EMBODIMENTS

Hereinafter, an embodiment of the present disclosure will be described below with reference to the drawings.

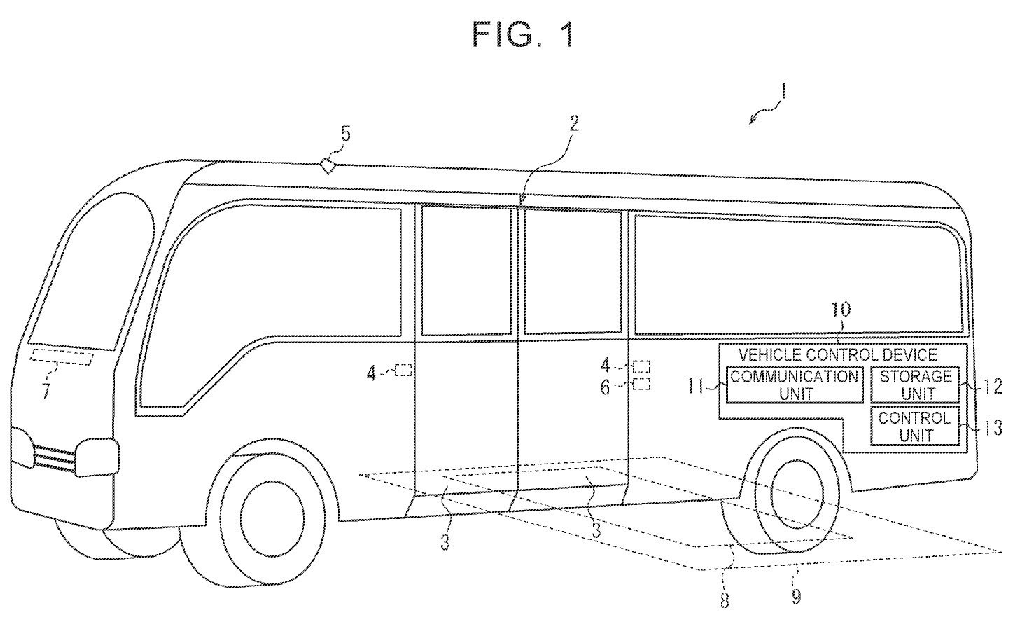

The vehicle 1 according to the present embodiment as illustrated in FIG. 1 is, for example, a MaaS dedicated vehicle, a bus vehicle, or the like. The vehicle 1 includes one entrance 2, two doors 3, two door actuators 4, a camera 5, a speaker 6, an output device 7, and a vehicle control device 10. From the entrance 2, the user gets into the vehicle 1. The two doors 3 are mounted so as to be openable and closable with respect to the entrance 2. The two door actuators 4 are each capable of opening and closing the two doors 3. The camera 5 is, for example, a bird view camera. However, the camera 5 may be any type of camera. The camera 5 is attached to the vehicle 1 so as to be able to capture an image of a landscape outside the vehicle 1. In the present embodiment, the camera 5 is attached to the vehicle 1 so as to be capable of capturing an image of a landscape in the vicinity of the entrance 2 of the vehicle 1 among landscapes outside the vehicle 1. The camera 5 is attached to, for example, an upper portion of the entrance 2 of the vehicle 1. The camera 5 generates an image by capturing a scene in the vicinity of the entrance 2 of the vehicle 1 at a predetermined frame rate set in advance. The camera 5 transmits data of the generated image to the vehicle control device 10. The speaker 6 is attached to the vehicle 1 so as to be capable of outputting an audio announcement to the outside of the vehicle 1. The output device 7 is capable of outputting information to the driver of the vehicle 1. The output device 7 is, for example, a display device, an audio output device, or the like. The vehicle control device 10 is disposed inside the vehicle 1, for example. The vehicle control device 10 includes a communication unit 11, a storage unit 12, and a control unit 13. The communication unit 11 includes at least one communication module capable of communicating with any component of the vehicle 1 including the door actuator 4, the camera 5, the speaker 6, and the output device 7. The communication module may be a module conforming to any of the wired communication standard and the wireless communication standard. The storage unit 12 includes at least one semiconductor memory or the like. The storage unit 12 stores data used for the operation of the vehicle control device 10 and data obtained by the operation of the vehicle control device 10. The storage unit 12 may store a program to be executed by the control unit 13. The control unit 13 includes at least one processor. The processor is, for example, a general-purpose processor such as a CPU or a special-purpose processor specialized for a particular process. The control unit 13 executes processing related to the operation of the vehicle control device 10 while controlling each unit of the vehicle control device 10.

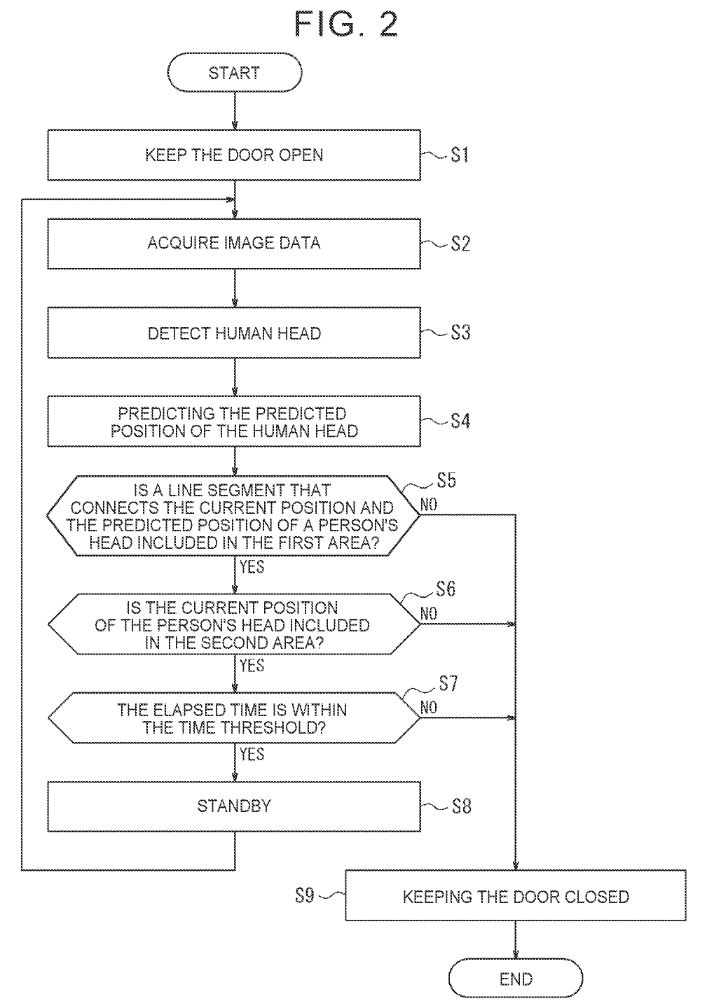

FIG. 2 is a flowchart illustrating an example of an operation of the vehicle control device 10 illustrated in FIG. 1. For example, the control unit 13 starts S1 when the vehicles 1 arrive at the stop.

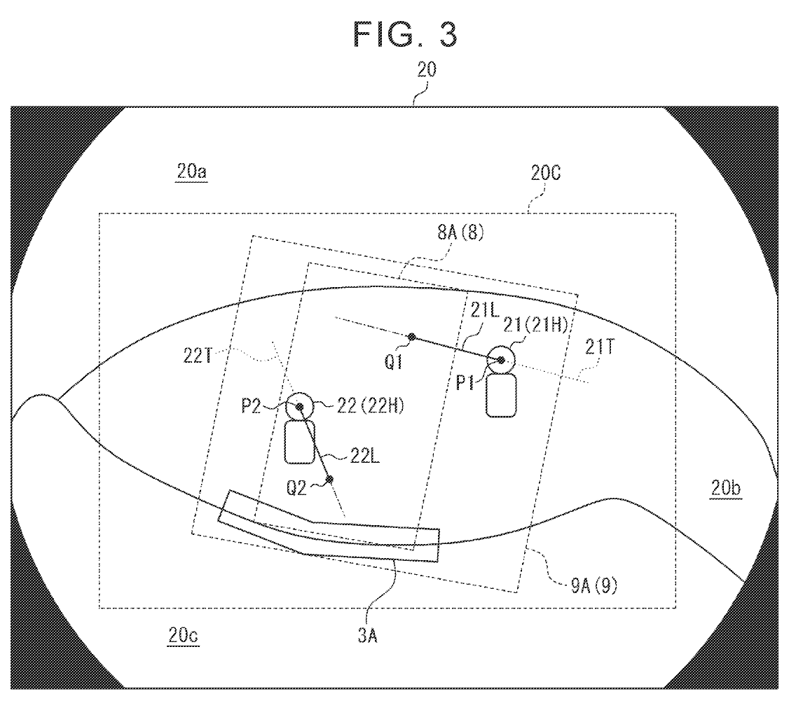

In S1, the control unit 13 transmits a control signal to the two actuators 4 by the communication unit 11, so that the two actuators 4 open the two doors 3 with respect to the entrance 2. In S2, the control unit 13 acquires the image data from the camera 5 by receiving the image data from the communication unit 11. For example, the control unit 13 acquires data of the image 20 as illustrated in FIG. 3. An empty space is shown in the area 20a of the images 20. In the area 20b of the images 20, the sidewalk in front of the stop is shown. The vehicle body of the vehicle 1 is shown in the area 20c of the images 20. Further, the image part 3A of the image 20 is drawn with the door 3.

In S3, the control unit 13 detects one or a plurality of persons by executing an object recognition process on the images acquired by S2. In the present embodiment, the control unit 13 detects the head of a person by executing an object recognition process on an image by detecting a person. However, detecting a person is not limited to detecting the head of a person. The control unit 13 may detect one or a plurality of heads by executing an object recognition process on a calculation area set out of the images acquired by S2. The calculation area may be set based on a design value of the lens of the camera 5 or the like. A calculation area 20C is set in the images 20 illustrated in FIG. 3. In FIG. 3, the control unit 13 detects a human head 21H, 22H by executing an object recognizing process on the images 20. In FIG. 3, the images 21, 22 respectively corresponding to the human head 21H, 22H are shown. In S3, when the head of the person is detected, the control unit 13 detects the position of the head of the detected person. In the present embodiment, the control unit 13 detects the position of the head of the person as the position of the coordinates in the real space. The position P1, P2 illustrated in FIG. 3 is a position on the images 20 corresponding to the positions of the human head 21H, 22H in the real space.

In S4, the control unit 13 predicts a predicted position of one or a plurality of heads detected by S3. For example, the control unit 13 predicts the predicted position of the head of the person after a predetermined period of time after detecting the head of the person in the latest S3. The predetermined time may be set based on a walking speed of a general person or the like. The control unit 13 predicts the position of the coordinates of the predicted position in the real space as the predicted position of the head of the person. Hereinafter, the position of the head of the person detected in the latest S3 is described as "present position of the head of the person". Here, depending on the process of S7 to be described later, S8 may be repeatedly executed from S2, so that S3 may be executed a plurality of times prior to executing S4. Here, the present position of the head of the person is the position of the head of the person detected in the most recent S3 of the plurality of S3. As an exemplary S4, the control unit 13 detects the trajectory of the head of the person along the time series based on the positions of the plurality of coordinates in the real space of the head of the person detected by the plurality of times of S3 executed prior to S4. The line 21T, 22T illustrated in FIG. 3 is a line on the images 20 corresponding to the trajectories of the human head 21H, 22H along the time series detected by the control unit 13. The control unit 13 predicts the coordinates of the predicted position of the head of the person in the real space by using the trajectory of the head of the person along the detected time series and the Kalman filter. The position Q1, Q2 illustrated in FIG. 3 is a position on the images 20 corresponding to predicted positions in the real space of the human head 21H, 22H.

S5 determines whether any of a plurality of line segments for one or a plurality of heads detected in the most recent S3 is included in the first area 8. The line segment for the head of a person is a line segment connecting the present position of the head of the person detected in the latest S3 and the predicted position of the head of the person predicted by the process of the latest S4. The line 21L, 22L shown in FIG. 3 are line segments on the images 20 corresponding to line segments for the human head 21H, 22H, respectively. One end of a line segment for a person's head is the current position of the person's head. The other end of the line segment for a person's head is the predicted position of the person's head. That is, a line segment for a person's head includes a current position and a predicted position of the person's head. The first area 8 is set in the vicinity of the entrance 2 as illustrated in FIG. 1, for example. The first area 8 may be set based on the width-direction D1 of the entrance 2 and the direction in which the user travels with respect to the entrance 2. The size of the width of the first area 8 may be the same as the size of the width of the entrance 2 or less than the size of the width of the entrance 2. The vertical size of the first area 8 may be set based on the frame rate of the camera 5 or the area of the stop, such as the walking speed of a general person. The area of the first area 8 is smaller than the area of the second area 9 described later. The area 8A illustrated in FIG. 3 is an area on the images 20 corresponding to the first area 8. The image 20 is a bird-view image, but for convenience of explanation, the area 8A is shown as a rectangle. When the control unit 13 determines that any one of the plurality of line segments for one or a plurality of heads detected in the latest S3 is included in the first area 8 (S5: YES), S6 proceeds. When the control unit 13 determines that none of the plurality of line segments for one or more heads detected in the latest S3 is included in the first area 8 (S5: NO), it determines that the person detected in S3 does not have a person who intends to get on the vehicle 1, and proceeds to S9.

In S6, the control unit 13 determines whether or not any of the present positions of one or a plurality of heads including a line segment for the head in the first area 8 is included in the second area 9. The second area 9 is set, for example, based on the width-direction D1 of the entrance 2 and the direction in which the user travels with respect to the entrance 2 as shown in FIG. 1. The size of the width of the second area 9 may be larger than the size of the width of the entrance 2. The vertical size of the second area 9 may be set based on a walking speed of a general person, a frame rate of the camera 5, an area of a stop, or the like. The area of the second area 9 is larger than the area of the first area 8. The second area 9 may be configured to include the first area 8. The area 9A illustrated in FIG. 3 is an area on the images 20 corresponding to the second area 9. The image 20 is a bird-view image, but for convenience of explanation, the area 9A is shown as a rectangle. When the control unit 13 determines that any of the present positions of one or a plurality of heads including a line segment for the head in the first area 8 is included in the second area 9 (S6: YES), it determines that the person detected by S3 has a person who intends to get on the vehicle 1. Then, the process proceeds to S7. When the control unit 13 determines that none of the present positions of one or a plurality of heads including a line segment for the head in the first area 8 is included in the second area 9 (S6: NO), it determines that the person detected by S3 has no intention of getting on the vehicle 1. Then, the process proceeds to S9. As described above, the determination result of S5, S6 is a determination result of whether or not the person detected by S3 is willing to get on the vehicle 1.

In S7, the control unit 13 determines whether the elapsed time is less than or equal to the time threshold. The elapsed time is a time elapsed after the vehicle 1 arrives at the stop. The time thresholds may be set based on a typical time at which a MaaS dedicated vehicle, a bus vehicle, or the like stops at a stop. When the control unit 13 determines that the elapsed time is less than or equal to the time threshold (S7: YES), the process proceeds to S8. When it is determined that the elapsed time exceeds the time threshold (S7: NO), the control unit 13 proceeds to S9. In S8, the control unit 13 waits for a predetermined period of time. The predetermined time may be set based on a walking speed of a general person or the like. After S8 process, the control unit 13 returns to S2. In the following S2, the control unit 13 acquires the image data of the next frame from the camera 5 by receiving the image data of the next frame by the communication unit 11. In S9, the control unit 13 transmits a control signal to the two actuators 4 by the communication unit 11, so that the two actuators 4 close the two doors 3 with respect to the entrance 2.

### Other cases of S9

As another example of S9, the control unit 13 may execute at least one of a notification process, a door control process, and a notification process to the driver of the vehicle 1 based on the determination result of the latest S5, S6. That is, the control unit 13 may execute at least one of a notification process, a door control process, and a notification process to the driver of the vehicle 1 based on a determination result of whether or not the detected person intends to get on the vehicle 1. As described above, the determination result of S5, S6 is a determination result of whether or not the person detected by S3 is willing to get on the vehicle 1. The notification process is a process of notifying information related to the control of the door of the vehicle 1. The door control process is a process of controlling the door 3 of the vehicle 1. However, the control unit 13 may execute a process according to another embodiment of S9 while waiting for a predetermined period of time in S8.

When the control unit 13 determines that the present position of the head of the person is included in the first area 8 according to S5 process, it may specify that the person is in the first area 8. When it is determined that there is a person in the first area 8, the control unit 13 executes at least one of the first notification processing, the first door control processing, and the first notification processing to the driver of the vehicle 1. The first notification process is a notification process of notifying the user that the door 3 closes soon. As the first notification processing, for example, the control unit 13 transmits a control signal to the speaker 6 to the communication unit 11 to cause the speaker 6 to output a sound "close the door soon". The first door control process is a process of delaying the timing of closing the door 3 more than usual. The first door control process may be a process of delaying the timing of closing the door 3 as compared with the second door control process described later. The control unit 13 executes the first door control process by transmitting a control signal to the two actuators 4 by the communication unit 11. The first notification process is a process of notifying the driver of the vehicle 1 that the closing of the door 3 is suppressed. As the first notification processing, the control unit 13 causes the output device 7 to display or output a display or sound indicating that the door should not be closed by transmitting a control signal to the output device 7 by the communication unit 11.

When the control unit 13 determines that the current position of the head of the person is included in the first area 8 as a result of S5 process and the current position of the head of the person different from the person is included in the second area 9 as a result of S6 process, it may specify that there are different persons in the first area 8 and the second area 9, respectively. When it is determined that there are different persons in the first area 8 and the second area 9, the control unit 13 executes at least one of the second notification processing, the first door control processing described above, and the first notification processing described above. The second notification process is a process of notifying that the door 3 is closed. The second notification process may be a notification process for prompting the user to get on the vehicle 1 earlier. As the second notification processing, for example, the control unit 13 causes the speaker 6 to output a sound "please get in early" by transmitting a control signal to the speaker 6 by the communication unit 11.

When the control unit 13 determines that the present position of the head of the person is included in the second area 9 according to S6 process, it may specify that the person is in the second area 9. When it is determined that a person is included in the second area 9, the control unit 13 executes at least one of the third notification processing, the second door control processing, and the second notification processing to the driver of the vehicle 1. The third notification process is a process of notifying that the door 3 is immediately closed. As the third notification processing, for example, the control unit 13 transmits a control signal to the speaker 6 to the communication unit 11 to cause the speaker 6 to output a sound "close the door". By the third notification processing and the first notification processing described above, the control unit 13 can change the notification content of the information related to the control of the door 3 between the case where the person is identified in the first area 8 and the case where the person is identified in the second area 9. The second door control process is a process of advancing the timing of closing the door 3 more than usual. The control unit 13 executes the second door control process by transmitting a control signal to the two actuators 4 by the communication unit 11. The second notification process is a process of notifying the driver of the vehicle 1 that there is a user who is likely to get on the vehicle 1. As the second notification processing, the control unit 13 causes the output device 7 to display or output a display or sound indicating "there may be a passenger" by transmitting a control signal to the output device 7 by the communication unit 11.

As described above, in the vehicle control device 10 according to the present embodiment, the control unit 13 repeatedly executes S2 to S8 and executes S2 a plurality of times to acquire time-series images from the cameras 5. The control unit 13 determines whether or not the person is willing to get on the vehicle 1 based on the result of determining whether or not the line segment including the detected current position and the predicted position of the person is included in the first area 8 and the result of determining whether or not the current position of the person is included in the second area. The area of the first area 8 is smaller than the area of the second area 9. Here, the specifications are different between the vehicle 1 and the elevator. For example, the stop of the vehicle 1 is wide unlike in front of the elevator. Therefore, when it is determined whether or not a person intends to get on the vehicle 1 in only one area as in JP-A-2017-124899, when the area is widened, there are cases where a passer who is not related to the user of the vehicle 1 is included. Further, when the area is widened, there is a possibility that a person who takes a long time to arrive at the entrance 2 is determined whether or not he/she is willing to ride. On the other hand, in a case where the area is narrowed, a person who is a target for determining whether or not the vehicle 1 is willing to ride is limited. In the present embodiment, it is possible to appropriately determine whether or not a person is willing to get on the vehicle 1 by using the first area 8 and the second area 9.

Although the present disclosure has been described above based on the drawings and the embodiment, it should be noted that those skilled in the art may make various modifications and alterations thereto based on the present disclosure. It should be noted, therefore, that these modifications and alterations are within the scope of the present disclosure. For example, the functions or the like included in each component or each step or the like can be rearranged so as not to logically contradict each other, and a plurality of components or steps or the like can be combined or divided into one.

For example, the control unit 13 may execute S1 at any timing later than S2. Alternatively, the control unit 13 may execute S1, S9, that is, the door control process at any timing based on the determination result of S5, S6, that is, based on the determination result of whether or not the detected person intends to get on the vehicle 1. Depending on the determination of S5, S6, the control unit 13 may not execute S1, S9. The control unit 13 may not execute S1 when it is determined that the person detected based on S5, S6 determination does not intend to get on the vehicle 1. The first area 8 and the second area 9 may be set for each stop of the vehicle 1.

What is claimed is:

1. A vehicle control device comprising a control unit that acquires time-series data of an image generated by capturing a scene outside a vehicle, wherein:
the control unit is configured to
when a person is detected based on the time-series data of the image, predict a predicted position of the detected person after a predetermined time, and
determine whether the detected person intends to ride on the vehicle based on a result of determining whether a line segment including a current position of the detected person and the predicted position of the detected person is included in a first area and a result of determining whether the current position of the detected person is included in a second area; and
an area of the first area is smaller than an area of the second area.

2. The vehicle control device according to claim 1, wherein the control unit determines that the detected person intends to ride on the vehicle when it is determined that the line segment is included in the first area and that the current position of the detected person is included in the second area.

3. The vehicle control device according to claim 1, wherein:
the control unit executes a door control process of controlling a door of the vehicle based on a determination result of whether the detected person intends to ride on the vehicle; and
a timing to close the door of the vehicle is delayed when it is specified that a person is present in the first area as compared with when it is specified that a person is present in the second area.

4. The vehicle control device according to claim 1, wherein the control unit is configured to
execute a notification process of indicating information relating to control of a door of the vehicle based on a determination result of whether the detected person intends to ride on the vehicle, and
change a notification content of the information relating to the control of the door between when it is specified that a person is present in the first area and when it is specified that a person is present in the second area.
